(19) United States
(12) Patent Application Publication
(10) Pub. No.: US 2007/0155884 A1
(43) Pub. Date: Jul. 5, 2007

(54) Filled olefin polymer compositions having improved mechanical properties and scratch resistance

(75) Inventors: Giampaolo Pellegatti, Baura (FE) (IT); Cheng Q. Song, Wilmington, DE (US); Vu A. Dang, Bear, DE (US); Jeanine A. Smith, West Grove, PA (US)

Correspondence Address: BASELL USA INC., INTELLECTUAL PROPERTY, 912 APPLETON ROAD, ELKTON, MD, 21921, US

(73) Assignee: Basell Poliolefine Italia s.r.l., Milan (IT)

(21) Appl. No.: 10/584,679

(22) PCT Filed: Nov. 12, 2004
(86) PCT No.: PCT/IB04/03734

§ 371 Date: Jun. 28, 2006

(51) Int. Cl. C08K 3/26

(52) U.S. Cl. 524/425; 524/494; 524/451; 524/449; 524/493; 524/437; 524/502

(57) ABSTRACT

Filled olefin polymer concentrates having improved mechanical properties and scratch resistance comprising: A. about 1.0 to about 40.0 wt % of an oxidized olefin polymer material; B. about 0.5 to about 40.0 of a maleated polypropylene; and C. about 7.0 to about 80.0 wt % of a filler chosen from fiberglass, carbon fibers, graphite fibers, whiskers, metal fibers, aramides, talc, wollastonite, calcium carbonate, mica, glass microspheres, ceramic microspheres, glass wool, rock wool, stainless steel wool, steel wool, gypsum, alumina, alumina-silica, silica, and mixtures thereof; wherein the sum of components A+B+C is equal to 100 wt %.

The present invention relates to filled olefin polymer compositions and filled olefin polymer concentrates having improved mechanical properties and scratch resistance.

Industrial and automotive applications frequently utilize filled polymer systems to provide desirable mechanical properties. Unfortunately, surface mechanical properties, such as the smoothness and scratch and mar resistance of filled systems, are often insufficient to meet commercial needs. To further improve the surface properties of filled polymer systems, it is common in the state of the art to include quantities of polyethylene wax in the polymer formulation. However, since polyethylene wax is a high melt flow rate material, its incorporation typically results in a deterioration in the mechanical properties of the polymer system. Japanese Patent No. 2003245967 describes compositions containing crosslinked polypropylene, maleated propylene and glass fibers. International patent application PCT/IB03/05401 discloses the use of irradiated, oxidized olefin polymer coupling agents for non-halogenated flame retardants and fillers. However, a need still exists for filled polymer compositions possessing good mechanical properties, scratch resistance and smoothness. It has unexpectedly been found that the compositions of the invention provide enhanced mechanical properties, as well as providing improved scratch resistance and surface smoothness.

In one embodiment, the present invention relates to a filled olefin polymer concentrate comprising:
A. about 1.0 wt % to about 40.0 wt % of an oxidized olefin polymer material containing from about 1 to about 200 mmol total peroxide per kilogram of oxidized olefin polymer;
B. about 0.5 wt % to about 40.0 wt % of a propylene polymer grafted with a monomeric vinyl acid, ester or anhydride;
C. about 7.0 wt % to about 80.0 wt % of a filler;
wherein the sum of components A+B+C is equal to 100.

In a second embodiment, the present invention relates to a filled olefin polymer composition comprising:
A. about 0.5 to about 30.0 wt % of an oxidized olefin polymer material containing from about 1 to about 200 mmol total peroxide per kilogram of oxidized olefin polymer;
B. about 0.2 to about 30.0 wt % of a propylene polymer grafted with a monomeric vinyl acid, ester or anhydride;
C. about 5.0 to about 60.0 wt % of a filler; and
D. about 15.0 to about 90.0 wt % of a non-oxidized olefin polymer material;
wherein the sum of components A+B+C+D is equal to 100 wt %.

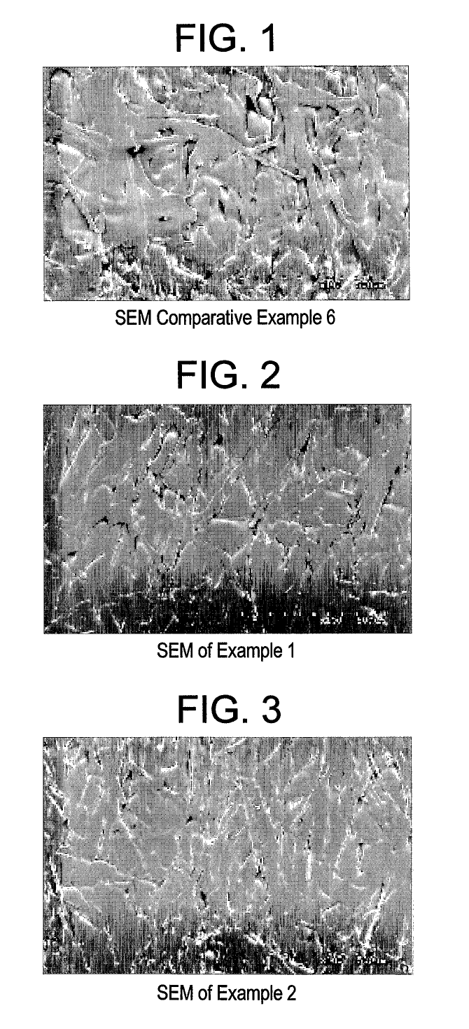

FIG. 1 is a scanning electron micrograph image of Comparative Example 6.

FIG. 2 is a scanning electron micrograph image of Example 1.

FIG. 3 is a scanning electron micrograph image of Example 2.

Olefin polymers suitable as a starting material for the oxidized olefin polymer material, and for the non-oxidized olefin polymer material used in the filled olefin polymer compositions of the invention include propylene polymer materials, ethylene polymer materials, butene-1 polymer materials, and mixtures thereof.

When a propylene polymer material is used as the non-oxidized olefin polymer material or as the starting material for the oxidized olefin polymer, the propylene polymer material can be:
(A) a homopolymer of propylene having an isotactic index greater than about 80%, preferably about 90% to about 99.5%;
(B) a random copolymer of propylene and an olefin chosen from ethylene and C₄-C₁₀ α-olefins, containing about 1 to about 30 wt % of said olefin, preferably about 1 to 20 wt %, and having an isotactic index greater than about 60%, preferably greater than about 70%;
(C) a random terpolymer of propylene and two olefins chosen from ethylene and C₄-C₈ α-olefins, containing about 1 to about 30 wt % of said olefins, preferably about 1 to 20 wt %, and having an isotactic index greater than about 60%, preferably greater than about 70%;
(D) an olefin polymer composition comprising:
   (i) about 10 parts to about 60 parts by weight, preferably about 15 parts to about 55 parts, of a propylene homopolymer having an isotactic index of at least about 80%, preferably about 90 to about 99.5%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than about 85% by weight, preferably about 90% to about 99%, and an isotactic index greater than about 60%;
   (ii) about 3 parts to about 25 parts by weight, preferably about 5 parts to about 20 parts, of a copolymer of ethylene and propylene or a C₄-C₈ α-olfin that is insoluble in xylene at ambient temperature; and
   (iii) about 10 parts to about 85 parts by weight, preferably about 15 parts to about 65 parts, of an elastomeric copolymer chosen from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than about 70% by weight, preferably about 10% to about 60%, most preferably about 12% to about 55%, of ethylene and being soluble in xylene at ambient temperature and having an intrinsic viscosity of about 1.5 to about 6.0 dl/g;
   the total of (ii) and (iii), based on the total olefin polymer composition being from about 50% to about 90%, and the weight ratio of (ii)/(iii) being less than about 0.4, preferably about 0.1 to about 0.3, wherein the composition is preferably prepared by polymerization in at least two stages; and
(E) mixtures thereof.

When an ethylene polymer material is used as the non-oxidized olefin polymer material or as the starting material for the oxidized olefin polymer material, the ethylene polymer material is chosen from (A′) homopolymers of ethylene, (B′) random copolymers of ethylene and an alpha-olefin chosen from C₃₋₁₀ alpha-olefins having a polymerized alpha-olfin content of about 1 to about 20% by weight, preferably about 1% to about 16%, (C′) random terpolymers of ethylene and two C₃-C₁₀ alpha olefins having a polymerized alpha-olfin content of about 1% to about 20% by weight, preferably, about 1% to about 16%, and (D′) mixtures thereof.

When a butene-1 polymer material is used as the non-oxidized olefin polymer material or as the starting material for the oxidized olefin polymer material, the useful polybutene-1 homo or copolymers are chosen from (A″) homopolymers of butene-1, (B″) copolymers or terpolymers of butene-1 with ethylene, propylene or C₅-C₁₀ alpha-olefins, the comonomer content ranging from about 1 mole % to about 15 mole %; and (C″) mixtures thereof. The useful polybutene-1 homo or copolymers can be isotactic or syndiotactic and have a melt flow rate (MFR) from about 0.1 to 150 dg/min, preferably from about 0.3 to 100, and most preferably from about 0.5 to 75.

These butene-1 polymer materials, their methods of preparation and their properties are known in the art. Suitable polybutene-1 polymers can be obtained, for example, by using Ziegler-Natta catalysts with butene-1, as described in WO 99/45043, or by metallocene polymerization of butene-1 as described in WO 02/102811, the disclosures of which are incorporated herein by reference.

Preferably, the butene-1 polymer materials contain up to about 15 mole % of copolymerized ethylene or propylene. More preferably, the butene-1 polymer material is a homopolymer having a crystallinity of at least about 30% by weight measured with wide-angle X-ray diffraction after 7 days, more preferably about 45% to about 70%, most preferably about 55% to about 60%.

The starting material for the oxidized olefin polymer material and the non-oxidized olefin polymer material in the compositions of the invention can be the same or different from each other.

In one method for preparing the oxidized olefin polymer material, the olefin polymer starting material is first exposed to high-energy ionizing radiation under a blanket of inert gas, preferably nitrogen. The ionizing radiation should have sufficient energy to penetrate the mass of polymer material being irradiated to the extent desired. The ionizing radiation can be of any kind, but preferably includes electrons and gamma rays. More preferred are electrons beamed from an electron generator having an accelerating potential of about 500 to about 4,000 kilovolts. Satisfactory results are obtained at a dose of ionizing radiation of about 0.1 to about 15 megarads (“Mrad”), preferably about 0.5 to about 9.0 Mrad.

The term “rad” is usually defined as that quantity of ionizing radiation that results in the absorption of 100 ergs of energy per gram of irradiated material regardless of the source of the radiation using the process described in U.S. Pat. No. 5,047,446. Energy absorption from ionizing radiation is measured by the well-known convention dosimeter, a measuring device in which a strip of polymer film containing a radiation-sensitive dye is the energy absorption sensing means. Therefore, as used in this specification, the term “rad” means that quantity of ionizing radiation resulting in the absorption of the equivalent of 100 ergs of energy per gram of the polymer film of a dosimeter placed at the surface of the olefin polymer material being irradiated, whether in the form of a bed or layer of particles, or a film, or a sheet.

The irradiated olefin polymer material is then oxidized, preferably in a series of steps. The first treatment step consists of heating the irradiated polymer in the presence of a first controlled amount of active oxygen greater than about 0.004% by volume but less than about 15% by volume, preferably less than about 8% by volume, more preferably less than about 5% by volume, and most preferably from about 1.3% to about 3.0% by volume, to a first temperature of at least about 25° C. but below the softening point of the polymer, preferably about 25° C. to about 140° C., more preferably about 25° C. to about 100° C., and most preferably about 40° C. to about 80° C. Heating to the desired temperature is accomplished as quickly as possible, preferably in less than about 10 minutes. The polymer is then held at the selected temperature, typically for about 5 to about 90 minutes, to increase the extent of reaction of the oxygen with the free radicals in the polymer. The holding time, which can be determined by one skilled in the art, depends upon the properties of the starting material, the active oxygen concentration used, the irradiation dose, and the temperature. The maximum time is determined by the physical constraints of the fluid bed.

In the second treatment step, the irradiated polymer is heated in the presence of a second controlled amount of oxygen greater than about 0.004% but less than about 15% by volume, preferably less than about 8% by volume, more preferably less than about 5% by volume, and most preferably from about 1.3% to about 3.0% by volume, to a second temperature of at least about 25° C. but below the softening point of the polymer. Preferably, the second temperature is from about 100° C. to less than the softening point of the polymer, and greater than the first temperature of the first step. The polymer is then held at the selected temperature and oxygen concentration conditions, for about 10 to about 300 minutes, preferably about 20 to about 180 minutes, to increase the rate of chain scission and to minimize the recombination of chain fragments so as to form long chain branches, i.e., to minimize the formation of long chain branches. The holding time is determined by the same factors discussed in relation to the first treatment step.

In the optional third step, the oxidized olefin polymer material is heated under a blanket of inert gas, preferably nitrogen, to a third temperature of at least about 80° C. but below the softening point of the polymer, and held at that temperature for about 10 to about 120 minutes, preferably about 60 minutes. A more stable product is produced if this step is carried out. It is preferred to use this step if the oxidized olefin polymer is going to be stored rather than used immediately, or if the radiation dose that is used is on the high end of the range described above. The polymer is then cooled to a fourth temperature of about 70° C. over a period of about 10 minutes under a blanket of inert gas, preferably nitrogen, before being discharged from the bed. In this manner, stable intermediates are formed that can be stored at room temperature for long periods of time without further degradation.

A preferred method of carrying out the treatment is to pass the irradiated olefin polymer through a fluid bed assembly operating at a first temperature in the presence of a first controlled amount of oxygen, passing the polymer through a second fluid bed assembly operating at a second temperature in the presence of a second controlled amount of oxygen, and then maintaining the polymer at a third temperature under a blanket of nitrogen, in a third fluid bed assembly. In commercial operation, a continuous process using separate fluid beds for the first two steps, and a purged, mixed bed for the third step is preferred. However, the process can also be carried out in a batch mode in one fluid bed, using a fluidizing gas stream heated to the desired temperature for each treatment step. Unlike some techniques, such as melt extrusion methods, the fluidized bed method does not require the conversion of the irradiated polymer into the molten state and subsequent re-solidification and comminution into the desired form. The fluidizing medium can be, for example, nitrogen or any other gas that is inert with respect to the free radicals present, e.g., argon, krypton, and helium.

The concentration of peroxide groups formed on the polymer can be controlled by varying the radiation dose during the preparation of the irradiated polymer and the amount of oxygen to which such polymer is exposed after irradiation. The oxygen level in the fluid bed gas stream is controlled by the addition of dried, filtered air at the inlet to the fluid bed. Air must be constantly added to compensate for the oxygen consumed by the formation of peroxides in the polymer.

Alternatively, the oxidized olefin polymer materials can be prepared according to the following procedures. In the first treatment step, the olefin polymer starting material is treated with 0.1 to 10 wt % of an organic peroxide initiator while adding a controlled amount of oxygen so that the olefin polymer material is exposed to greater than 0.004% but less than 21% by volume, preferably less than 15%, more preferably less than 8% by volume, and most preferably 1.0% to 5.0% by volume; at a temperature of at least 25° C. but below the softening point of the polymer, preferably about 25° C. to about 140° C. In the second treatment step, the polymer is then heated to a temperature of at least 25° C. up to the softening point of the polymer, preferably from 100° C. to less than the softening point of the polymer, at an oxygen concentration that is within the same range as in the first treatment step. The total reaction time is typically about 0.5 hour to four hours. After the oxygen treatment, the polymer is treated at a temperature of at least 80° C. but below the softening point of the polymer, typically for 0.5 hour to about two hours, in an inert atmosphere such as nitrogen to quench any active free radicals.

Suitable organic peroxides include acyl peroxides, such as benzoyl and dibenzoyl peroxides; dialkyl and aralkyl peroxides, such as di-tert-butyl peroxide, dicumyl peroxide; cumyl butyl peroxide; 1,1,-di-tert-butylperoxy-3,5,5-trimethylcyclohexane; 2,5-dimethyl-1,2,5-tri-tert-butylperoxyhexane,and bis(alpha-tert-butylperoxy isopropylbenzene), and peroxy esters such as bis(alpha-tert-butylperoxy pivalate; tert-butylperbenzoate; 2,5-dimethylhexyl-2,5-di(perbenzoate); tert-butyl-di(perphthalate); tert-butylperoxy-2-ethylhexanoate, and 1,1 -dimethyl-3-hydroxybutylperoxy-2-ethyl hexanoate, and peroxycarbonates such as di(2-ethylhexyl) peroxy dicarbonate, di(n-propyl)peroxy dicarbonate, and di(4-tert-butylcyclohexyl)peroxy dicarbonate. The peroxides can be used neat or in diluent medium.

The oxidized olefin polymer material used in compositions of the invention preferably contains greater than about 1 mmol total peroxide per kilogram of oxidized olefin polymer material. More preferably, the oxidized olefin polymer material contains from greater than about 1 to about 200 mmol total peroxide per kilogram of oxidized olefin polymer material, most preferably from about 5 to about 100 mmol total peroxide per kilogram of oxidized olefin polymer material.

The number average molecular weight (Mₙ) of the oxidized olefin polymers is preferably greater than about 10,000, although it may be lower in some cases.

Preferably, the starting material for making the oxidized olefin polymer material, and the non-oxidized olefin polymer material is a propylene polymer material. More preferably, the starting material is a propylene homopolymer having an isotactic index greater than about 80%. The oxidized olefin polymer material is preferably prepared by irradiation followed by exposure to oxygen as described herein above.

Suitable fillers include reinforcing fibers such as fiberglass, carbon fibers, graphite fibers, metal fibers, whiskers and aramides; inert fillers such as talc, wollastonite, mica, calcium carbonate, glass microspheres, ceramic microspheres, glass wool, rock wool, stainless steel wool, steel wool, and gypsum; ceramic fibers such as alumina, alumina silica and silica; and mixtures thereof. The inert fillers of the invention are preferably present as finely divided solids with a particle size range of from about 0.8 to about 40 microns. When present as fiberglass, the filler can include those commercially available glass fibers typically marketed as reinforcing agents. The glass fibers can be in the form of short fibers, typically from about 1.6 mm to about 7.9 mm in length; long fibers, typically from about 12.7 to about 51 mm in length; or in the form of continuous filament fibers. Preferably, the filler is fiberglass.

The propylene polymer grafted with a monomeric vinyl acid, ester or anhydride can be made by any process known in the state of the art. Preferably, the propylene polymer is grafted with a C₃-C₂₀ monomeric vinyl acid, ester or anhydride, and more preferably with methacrylic acid, acrylic acid, maleic acid or anhydrides thereof. Most preferably, the propylene polymer is grafted with maleic anhydride. The content of the monomer vinyl acid, ester or anhydride is preferably from about 0.2 wt % to about 10.0 wt %, based on the weight of the grafted propylene polymer. More preferably, the content of the monomer vinyl acid, ester or anhydride level is from about 0.3 wt % to about 7.0 wt %, most preferably from about 0.4 wt % to about 5.0 wt %.

In the filled olefin polymer concentrate of the invention, the filler material is present in an amount from about 7.0 wt % to about 80.0 wt %, preferably the filler is present in an amount from about 10.0 wt % to about 75.0 wt %, more preferably, the filler is present in an amount from about 20.0 wt % to about 70.0 wt %.

The oxidized olefin polymer material is present in an amount from about 1.0 wt % to about 40.0 wt %, preferably about 5.0 wt % to about 35.0 wt %, more preferably about 10.0 wt % to about 30.0 wt %.

The propylene polymer grafted with a monomeric vinyl acid, ester or anhydride is present in an amount from about 0.5 wt % to about 40.0 wt %, preferably about 1.0 wt % to about 20.0 wt %, more preferably, about 2.0 wt % to about 10.0 wt %.

In a filled olefin polymer composition of the invention, the filler material is present in an amount from about 5.0 wt % to about 60.0 wt %, preferably the filler is present in an amount from about 10.0 wt % to about 50.0 wt %, more preferably, the filler is present in an amount from about 20.0 wt % to about 40.0 wt %.

The oxidized olefin polymer material is present in an amount from about 0.50 wt % to about 30.0 wt %, preferably about 1.0 wt % to about 25.0 wt %, more preferably about 5.0 to about 20.0 wt %.

The propylene polymer grafted with a monomeric vinyl acid, ester or anhydride is present in an amount from about 0.2 wt % to about 30.0 wt %, preferably about 0.3 wt % to about 10.0 wt %, more preferably, about 0.5 wt % to about 3.0 wt %.

When present, the non-oxidized olefin polymer material is present in an amount from about 15.0 wt % to about 90.0 wt %, preferably about 20.0 wt % to about 80.0 wt %, more preferably about 30.0 wt % to about 75.0 wt %.

The oxidized olefin polymer material, filler, propylene polymer grafted with a monomeric vinyl acid, ester or anhydride, and optionally a non-oxidized olefin polymer material can be combined at ambient temperature in conventional operations well known in the art; including, for example, drum tumbling, or with low or high speed mixers. The resulting composition is then compounded in the molten state in any conventional manner well known in the art, in batch or continuous mode; for example, by using a Banbury mixer, a kneading machine, or a single or twin screw extruder. The material can then be pelletized.

Melt flow rate (“MFR”) was determined by ASTM D1238 at 230° C. at 2.16 kg, and are reported in units of dg/min. Isotactic Index (“I.I.”) is defined as the percent of propylene polymer insoluble in xylene. The weight percent of propylene polymer soluble in xylene at room temperature is determined by dissolving 2.5 g of polymer in 250 ml of xylene at room temperature in a vessel equipped with a stirrer, and heating at 135° C. with agitation for 20 minutes. The solution is cooled to 25° C. while continuing the agitation, and then left to stand without agitation for 30 minutes so that the solids can settle. The solids are filtered with filter paper, the remaining solution is evaporated by treating it with a nitrogen stream, and the solid residue is vacuum dried at 80° C. until a constant weight is reached. These values correspond substantially to the isotactic index determined by extracting with boiling n-heptane, which by definition constitutes the isotactic index of polypropylene. The peroxide content of the propylene oxidized olefin polymers is as described in Quantitative Organic Analysis via Functional Groups, by S. Siggia et al., 4^{th} Ed., NY, Wiley 1979, pp. 334-42. Tensile strength at yield was measured according to ASTM D638-89. Flexural Modulus and Flex Strength at yield was measured according to ASTM D790-92. Heat Distortion Temperature was measured according to ASTM D648-01B. Elongation at Yield was measured according to ASTM D638-89.

Scanning electron micrograph imaging was performed on a Hitachi S3500 scanning electron microscope, commercially available from Hitachi. The tested samples were sputter-coated with gold before analysis by SEM.

Scratch resistance was measured using Ford Laboratory Test Method BN 108-13 (resistance to scratching). The apparatus included several weighted pins that rested on the surface of the test specimen. The pins used for the scratch test were 1.0 mm highly polished steel balls and the pins used for the mar test were 7.0 mm balls. The pins were loaded with different weights exerting the following standard forces on the surface of the test material: 20.0 Newtons (N); 15.0 N; 10.0 N; 7.0 N; 5.0 N. The pins were then pulled along the panel. All scratch lines were examined and rated according to a rating scale of 1 to 5, with 1=no scratch line at all and 5═severe scratching. The scratch resistance test was performed five times and the results of the five tests were totaled.

### Preparation 1

A polypropylene homopolymer having a MFR of 0.3 dg/min and I.I. of 96.8, commercially available from Basell USA Inc. was irradiated at 0.5 Mrad under a blanket of nitrogen. The irradiated polymer was then treated with 2.2% by volume of oxygen at 65° C. for 1 hour, and then with 2.2% by volume of oxygen at 130° C. for an additional 1 hour. The oxygen was then removed. The polymer was then heated at 130° C. under a blanket of nitrogen for 1 hour, cooled and collected. The MFR of the extruded polymer was 1300 dg/min. The peroxide content of the oxidized propylene polymer was 35 mmol total peroxide per kilogram of oxidized propylene polymer.

### Preparation 2

A polypropylene homopolymer having an MFR of 0.7 dg/min and xylene insoluble fraction of 95.6% commercially available from Basell USA Inc. was irradiated at 0.5 Mrad under a blanket of nitrogen. The irradiated polymer was then treated with 2.5% by volume of oxygen at 55° C. for 5 minutes and then with 2.5% by volume of oxygen at 140° C. for an additional 60 minutes. The oxygen was then removed. The polymer was then heated at 140° C. under a blanket of nitrogen for 60 minutes, cooled and collected. The MFR of the extruded polymer was 1800 dg/min. The peroxide content of the oxidized propylene polymer was 26 mmol peroxide per kilogram oxidized propylene polymer.

### EXAMPLES 1-4 and COMPARATIVE EXAMPLES 5-8

The samples prepared in Preparations 1 and 2 as reported above were dry blended with AO 330, an antioxidant commercially available from Albermale, and calcium stearate. PPG-3793 fiberglass, commercially available from PPG Industries, and non-oxidized propylene homopolymer, commercially available from Basell USA Inc., having a MFR of 0.32 and I.I. of 95.6, were separately fed into a ZSK 40 mm twin-screw extruder, commercially available from Coperion, and compounded at 210-230° C. All materials were then molded on a 155 gram Batenfeld injection molding machine, commercially available from Batenfeld, at a mold temperature of 70° C. All samples contained 1% Polybond 3200, a maleated polypropylene commercially available from Crompton Corporation, having a maleic anhydride level of 1.0 wt %. The compositions of Comparative Examples 7 and 8 also comprised a polyethylene wax, AC-6, commercially available from Honeywell International AIc.

The compositions, mechanical properties and scratch resistance of Examples 1-4 and Comparative Examples 5-8 are set forth in Table 1.

TABLE 1

| | Ex. 1 | Ex. 2 | Ex. 3 | Ex. 4 | Comp. Ex. 5 | Comp. Ex. 6 | Comp. Ex. 7 | Comp. Ex. 8 |
|---|---|---|---|---|---|---|---|---|
| Fiberglass (wt %) | 29.95 | 29.95 | 29.95 | 29.95 | 29.95 | 29.95 | 29.95 | 29.95 |
| Non-oxidized propylene | 66.89 | 63.89 | 66.89 | 63.89 | 69.88 | 68.88 | 66.89 | 63.89 |
| homopolymer (wt %) | | | | | | | | |
| Maleated polypropylene | 1.00 | 1.00 | 1.00 | 1.00 | — | 1.00 | 1.00 | 1.00 |
| (wt %) | | | | | | | | |
| PE wax (wt %) | — | — | — | — | — | — | 2.00 | 4.99 |
| Oxidized olefin polymer of | 2.00 | 4.99 | — | — | — | — | — | — |
| preparation 2 (wt %) | | | | | | | | |
| Oxidized olefin polymer of | — | — | 2.00 | 4.99 | — | — | — | — |
| preparation 1 (wt %) | | | | | | | | |
| Antioxidant (wt %) | 0.10 | 0.10 | 0.10 | 0.10 | 0.10 | 0.10 | 0.10 | 0.10 |
| Calcium Stearate (wt %) | 0.07 | 0.07 | 0.07 | 0.07 | 0.07 | 0.07 | 0.07 | 0.07 |
| Mechanical Properties | | | | | | | | |
| HDT @ high load 1.81 MPa | 123 | 120 | 119 | 132 | 118 | 120 | 115 | 109 |
| (° C.) | | | | | | | | |
| HDT @ low load 0.47 MPa | 150+ | 149 | 150+ | 150+ | nd | 147 | 148 | 144 |
| (° C.) | | | | | | | | |
| Tensile Strength (MPa) | 51.2 | 51.8 | 52.1 | 55.4 | 41.1 | 49.6 | 48.6 | 47.1 |
| Elongation at Yield (%) | 1.15 | 1.13 | 1.15 | 1.22 | 1.0 | 1.14 | 1.08 | 1.04 |
| Flex Modulus @ 1% (MPa) | 4790 | 4872 | 4852 | 4890 | 4876 | 4691 | 4707 | 4534 |
| secant | | | | | | | | |
| Flex Strength (MPa) | 71.7 | 72.4 | 71.7 | 76.6 | 62.1 | 69.0 | 68.4 | 65.2 |
| Scratch resistance | 15 | 11 | nd | nd | nd | 18 | 16 | 20 |

As is evident from the data in Tables 1, the mechanical properties of the glass filled blends containing oxidized olefin polymer material and maleated polypropylene provide an improved balance of mechanical properties relative to the comparative examples, even containing polyethylene wax. In addition, samples containing the oxidized olefin polymer material and maleated polypropylene provide improved scratch resistance.

The SEM images of FIGS. 2 and 3 demonstrate that the compositions of Examples 1 and 2 according to the present invention, containing oxidized olefin polymer material and maleated polypropylene, have improved surface smoothness relative to that of Comparative Example 6.

Other features, advantages and embodiments of the invention disclosed herein will be readily apparent to those exercising ordinary skill after reading the foregoing disclosures. In this regard, while specific embodiments of the invention have been described in considerable detail, variations and modifications of these embodiments can be effected without departing from the spirit and scope of the invention as described and claimed.

1. A filled olefin polymer concentrate comprising:
A. about 1.0 to about 40.0 wt % of an oxidized olefin polymer material containing from about 1 to about 200 mmol total peroxide per kilogram of oxidized olefin polymer;
B. about 0.5 to about 40.0 of a propylene polymer grafted with a monomeric vinyl acid, ester or anhydride; and
C. about 7.0 to about 80.0 wt % of a filler chosen from fiberglass, carbon fibers, graphite fibers, whiskers, metal fibers, aramides, talc, wollastonite, calcium carbonate, mica, glass microspheres, ceramic microspheres, glass wool, rock wool, stainless steel wool, steel wool, gypsum, alumina, alumina-silica, silica, and mixtures thereof;
wherein the sum of components A+B+C is equal to 100 wt %.

2. The composition of claim 1 wherein the oxidized olefin polymer material comprises a polymer of propylene, ethylene, butene-1 or mixtures thereof.

3. The composition of claim 2 wherein the oxidized olefin polymer material comprises a polymer of propylene chosen from
(A) a homopolymer of propylene having an isotactic index greater than about 80%,
(B) a random copolymer of propylene and an olefin chosen from ethylene and C₄-C₁₀ α-olefins, containing about 1 to about 30 wt % of said olefin, and having an isotactic index greater than about 60%;
(C) a random terpolymer of propylene and two olefins chosen from ethylene and C₄-C₈ α-olefins, containing about 1 to about 30 wt % of said olefins, and having an isotactic index greater than about 60%;
(D) an olefin polymer composition comprising:
(i) about 10 parts to about 60 parts by weight of a propylene homopolymer having an isotactic index of at least about 80%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than about 85% by weight, and an isotactic index greater than about 60%;
(ii) about 3 parts to about 25 parts by weight, of a copolymer of ethylene and propylene or a C₄-C₈ α-olefin that is insoluble in xylene at ambient temperature; and
(iii) about 10 parts to about 85 parts by weight, of an elastomeric copolymer chosen from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than about 70% by weight, of ethylene and being soluble in xylene at ambient temperature and having an intrinsic viscosity of about 1.5 to about 6.0 dl/g;
the total of (ii) and (iii), based on the total olefin polymer composition being from about 50% to about 90%, and the weight ratio of (ii)/(iii) being less than about 0.4; and
(E) mixtures thereof.

4. The composition of claim 3 wherein the oxidized olefin polymer material is a homopolymer of propylene having an isotactic index greater than about 80%.

5. The composition of claim 2 wherein the oxidized olefin polymer material comprises a polymer of ethylene chosen from (A′) homopolymers of ethylene, (B′) random copolymers of ethylene and an α-olefin selected from C₃-C₁₀ α-olefins having a polymerized α-olefin content of about 1 to about 20% by weight, (C′) random terpolymers of ethylene and C₃-C₁₀ α-olefins having a polymerized α-olefin content of 1 to 20% by weight, and (D′) mixtures thereof.

6. The composition of claim 2 wherein the oxidized olefin polymer material comprises a polymer of butene-1 chosen from (A″) homopolymers of butene-1, (B″) copolymers or terpolymers of butene-1 with ethylene, propylene or C₅-C₁₀ alpha-olefin, the comonomer content ranging from about 1% by weight to about 20% by weight, and (C″) mixtures thereof.

7. The composition of claim 1 wherein component B is present in an amount from about 1.0 wt % to about 20.0 wt %.

8. The composition of claim 1 wherein component A is present in an amount from about 5.0 wt % to about 35.0 wt %.

9. The composition of claim 1 wherein component C is present in an amount from about 10.0 wt % to about 75.0 wt %.

10. The composition of claim 1 wherein component C is fiberglass.

11. The composition of claim 1 where component B is a propylene polymer grafted with maleic anhydride.

12. A filled olefin polymer composition comprising:
A. about 0.5 wt % to about 30.0 wt % of an oxidized olefin polymer material containing from about 1 to about 200 mmol total peroxide per kilogram of oxidized olefin polymer;
B. about 0.2 wt % to about 30.0 wt % of a propylene polymer grafted with a monomeric vinyl acid, ester or anhydride.
C. about 5.0 wt % to about 60.0 wt % of a filler chosen from fiberglass, carbon fibers, graphite fibers, metal fibers, whiskers, aramides, talc, wollastonite, calcium carbonate, mica, glass microspheres, ceramic microspheres, glass wool, rock wool, stainless steel wool, steel wool, gypsum, alumina, alumina-silica, silica, and mixtures thereof; and
D. about 15.0 to about 90.0 wt % of a non-oxidized olefin polymer material;
wherein the sum of components A+B+C+D is equal to 100 wt %.

13. The composition of claim 12 wherein the oxidized olefin polymer material is chosen from:
(A) a homopolymer of propylene having an isotactic index greater than about 80%;
(B) a random copolymer of propylene and an olefin chosen from ethylene and C₄-C₁₀ α-olefins, containing about 1 to about 30 wt % of said olefin, and having an isotactic index greater than about 60%;
(C) a random terpolymer of propylene and two olefins chosen from ethylene and C₄-C₈ α-olefins, containing about 1 to about 30 wt % of said olefins, and having an isotactic index greater than about 60%;
(D) an olefin polymer composition comprising:
(i) about 10 parts to about 60 parts by weight, of a propylene homopolymer having an isotactic index of at least about 80%, or a crystalline copolymer chosen from (a) propylene and ethylene, (b) propylene, ethylene and a C₄-C₈ α-olefin, and (c) propylene and a C₄-C₈ α-olefin, the copolymer having a propylene content of more than about 85% by weight, and an isotactic index greater than about 60%;
(ii) about 3 parts to about 25 parts by weight, of a copolymer of ethylene and propylene or a C₄-C₈ α-olefin that is insoluble in xylene at ambient temperature; and
(iii) about 10 parts to about 85 parts by weight, of an elastomeric copolymer chosen from (a) ethylene and propylene, (b) ethylene, propylene, and a C₄-C₈ α-olefin, and (c) ethylene and a C₄-C₈ α-olefin, the copolymer optionally containing about 0.5% to about 10% by weight of a diene, and containing less than about 70% by weight, of ethylene and being soluble in xylene at ambient temperature and having an intrinsic viscosity of about 1.5 to about 6.0 dl/g;
the total of (ii) and (iii), based on the total olefin polymer composition being from about 50% to about 90%, and the weight ratio of (ii)/(iii) being less than about 0.4; and
(E) mixtures thereof.

14. The composition of claim 13 wherein the oxidized olefin polymer material is a homopolymer of propylene having an isotactic index greater than about 80%.

15. The composition of claim 12 wherein the oxidized olefin polymer material is chosen from (A′) homopolymers of ethylene, (B′) random copolymers of ethylene and an α-olfin selected from C₃-C₁₀ α-olefins having a polymerized α-olefin content of about 1 to about 20% by weight, (C′) random terpolymers of ethylene and C₃-C ₁₀ α-olefins having a polymerized α-olefin content of 1 to 20% by weight, and (D′) mixtures thereof.

16. The composition of claim 12 wherein the oxidized olefin polymer material is chosen from (A″) homopolymers of butene-1, (B″) copolymers or terpolymers of butene-1 with ethylene, propylene or C₅-C₁₀ alpha-olefin, the comonomer content ranging from about 1 mole % to about 15 mole %, and (C″) mixtures thereof.

17. The composition of claim 12 wherein component A is present in an amount from about 1.0 to about 25.0 wt %

18. The composition of claim 12 wherein component B is present in an amount from about 0.3 to about 10.0 wt %.

19. The composition of claim 12 wherein component C is present in an amount from about 10.0 to about 50.0 wt %.

20. The composition of claim 12 wherein component C is fiberglass

21. The composition of claim 12 wherein component B is a propylene polymer grafted with maleic anhydride.
